(19) United States
(12) Patent Application Publication
(10) Pub. No.: US 2017/0277832 A1
(43) Pub. Date: Sep. 28, 2017

(54) Outpatient-Guiding System

(71) Applicant: Tzu-Hsiang Tseng, Taichung City (TW)

(72) Inventor: Tzu-Hsiang Tseng, Taichung City (TW)

(21) Appl. No.: 15/077,871

(22) Filed: Mar. 22, 2016

(51) Int. Cl. G06F 19/00

(52) U.S. Cl. CPC G06F 19/322

(57) ABSTRACT

An outpatient-guiding system includes a patient-data recording module recoding a patient's face-image data, appointment time and appointed department; video cameras installed in a hospital; an image-capturing module using the video cameras to capture the patient's face images and location information; an image-recognizing module comparing the patient's face images to the recorded data so as to determine the patient's identity; a path-planning module, according to the patient's identity and the location information of the video cameras, calculating the patient's present location and planning a proceeding path toward the appointed department; view-displaying modules, according to the patient's present location and proceeding path, displaying outpatient-guiding information; and at least two voice-broadcasting modules, according to the patient's present location and proceeding path, broadcasting outpatient-guiding information. Thereby, the system guides the patient to the department/clinic room for his/her appointment accurately and promptly.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to an outpatient-guiding system, wherein the outpatient-guiding system is capable of recognizing patients and using visual and acoustic means to indicate paths for the patients to respective departments/clinic rooms in a hospital.

Description of Related Arts

In a large general hospital, there are many departments and clinic rooms. After registered at the hospital's registration office or made appointment by phone or on line, a patient has to go to the department or clinic room for his/her doctor timely. Although signposts are usually provided throughout the hospital, the numerous names of the departments may be unfamiliar and confusing to the patient. In many cases, the patient has to consult a passing-by medical staff member or even ask the staff member to show him/her the way. For those hospitals do not have sufficient labor power to guide patients, their already-too-busy staff suffers from these incessant requests, and this can degrade their crucial, life-saving job. Even if the medical staff members can put up with it for the time being, the medical quality is unavoidably reduced and the heavy stress may eventually drive them to depression and resignation. This can create a vicious circle that is lose-lose to hospitals and patients. Thus, there is an unmet need for a nosocomial guide system that helps hospitals to guide outpatients.

### SUMMARY OF THE PRESENT INVENTION

The primary objective of the present invention is to address the need discussed above by providing an outpatient-guiding system, which uses images to identify and locate a patient, and then according to the patient's anamnesis data and appointment details plans a path and guides the patient to the department/clinic room he/she is supposed to show up.

To achieve the aforementioned objective, an outpatient-guiding system according to the present invention comprises: a patient-data recording module, a plurality of video cameras, an image-capturing module, an image-recognizing module, a path-planning module, a plurality of view-displaying modules and a plurality of voice-broadcasting modules; therein, the patient-data recording module recording anamnesis data, face-image data, and appointment details of a patient, and using the appointment details to obtain an appointment time and an appointed department related to the patient and a hospital; the video cameras being installed in passageways and corridors of the hospital; the image-capturing module using the video cameras to capture face images of the patient and location information of the video cameras; the image-recognizing module comparing the patient's face images input by the image-capturing module to the face-image data stored in the patient-data recording module for apparent features, so as to determine the patient's identity; the path-planning module, according to the patient's identity determined by the image-recognizing module and according to the location information of the video cameras, calculating the patient's present location and planning a proceeding path toward the appointed department; the view-displaying modules being deployed along the hospital's passageways and corridors, and, according to the patient's present location and proceeding path planned by the path-planning module, displaying outpatient-guiding information through the view-displaying module locationally closest to the patient; and the plurality of voice-broadcasting modules being deployed along the hospital's passageways and corridors, and, according to the patient's present location and proceeding path planned by the path-planning module, broadcasting outpatient-guiding information using the voice-broadcasting module locationally closest to the patient.

In one embodiment of the present invention, after the image-recognizing module determines the patient's identity, the image-capturing module captures body feature images of the patient and then captures body feature images of all individuals presenting in vision scope of the video cameras for a predetermined time period, after which the image-recognizing module identifies those body feature images that match the body feature images of the patient, and for individuals having those body feature images that match the body feature images of the patient, the image-capturing module captures face images thereof and records these face images into the patient-data recording module.

In one embodiment of the present invention, the system further includes a list-screening module.

In one embodiment of the present invention, the list-screening module contains a blacklist prepared by the hospital or a blocked-person list provided by a public security authority.

With the disclosed system, a patient can accurately and promptly arrive at the appointed department/clinic room without needing medical staff's guidance. Thus, the disclosed system helps the hospital save labor costs and enhance efficiency of its medical services.

### BRIEF DESCRIPTION OF THE DRAWINGS

FIG. 1 is a structural block diagram of one embodiment of the present invention; and

FIG. 2 is a structural block diagram of another embodiment of the present invention.

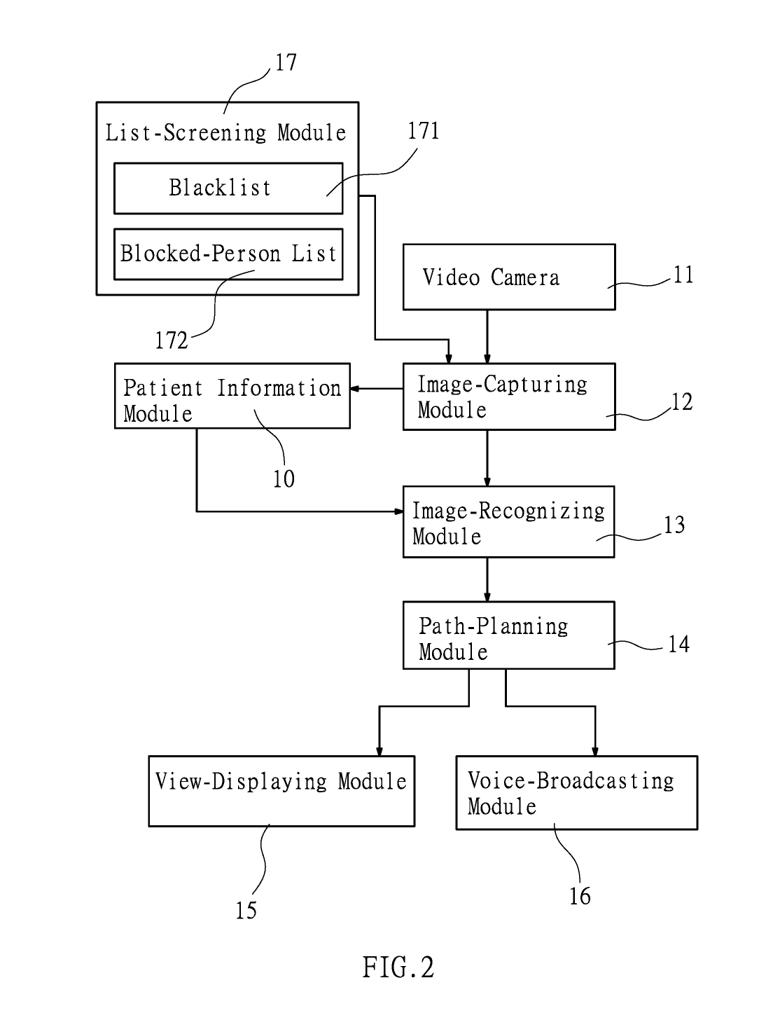

### DETAILED DESCRIPTION OF THE PREFERRED EMBODIMENT

The invention as well as a preferred mode of use, further objectives and advantages thereof will be best understood by reference to the following detailed description of illustrative embodiments when read in conjunction with the accompanying drawings.

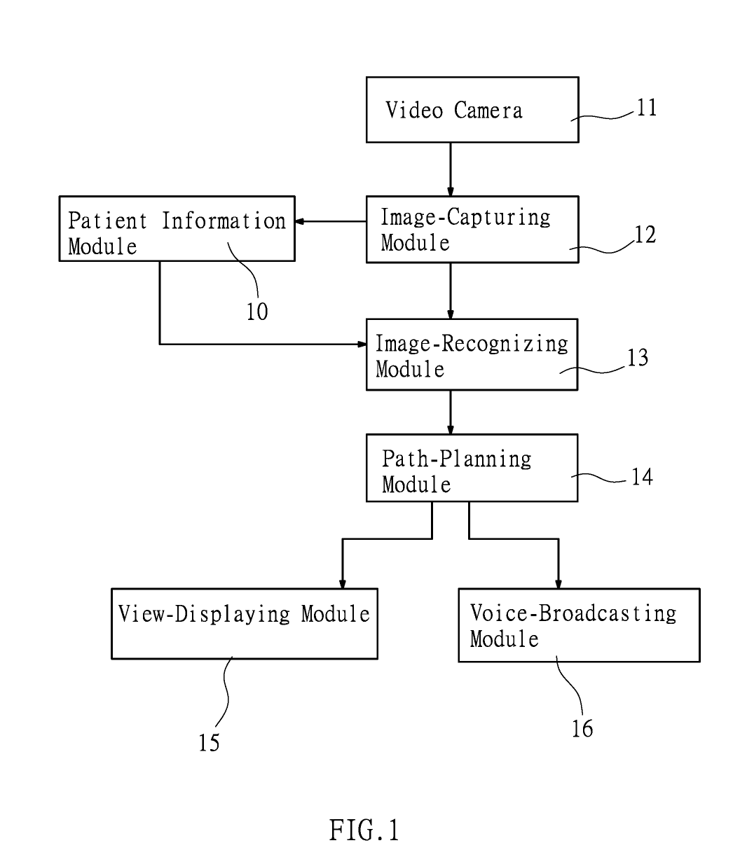

Referring to FIG. 1, according to one embodiment of the present invention, an outpatient-guiding system comprises: a patient-data recording module 10, recording anamnesis data, face-image data, and appointment details of a patient, and using the appointment details to obtain an appointment time and an appointed department related to the patient and a hospital; a plurality of video cameras 11, being installed in passageways and corridors of the hospital; an image-capturing module 12, using the video cameras 11 to capture face images of the patient and location information of the video cameras 11; an image-recognizing module 13, comparing the patient's face images input by the image-capturing module 12 to the face-image data stored in the patient-data recording module 10 for apparent features, so as to determine the patient's identity; a path-planning module 14, according to the patient's identity determined by the image-recognizing module 13 and according to the location information of the video cameras 11, calculating the patient's present location and planning a proceeding path toward the appointed department; a plurality of view-displaying modules 15, being deployed along the hospital's passageways and corridors, and, according to the patient's present location and proceeding path planned by the path-planning module 14, displaying outpatient-guiding information through the view-displaying module 15 locationally closest to the patient; and a plurality of voice-broadcasting modules 16, being deployed along the hospital's passageways and corridors, and, according to the patient's present location and proceeding path planned by the path-planning module 14, broadcasting outpatient-guiding information using the voice-broadcasting module 16 locationally closest to the patient. This allows the patient to be guided to the appointed department/clinic room accurately without needing manual guidance, thereby helping the hospital save labor costs and enhance efficiency of its medical services. This system is particularly helpful to individuals with visual disability and problems.

The operation and effects of the foregoing embodiment are hereinafter explained. Referring to FIG. 1, the patient-data recording module 10 records images of the patient's facial features taken from multiple angles (e.g. front, lateral, angled lateral, etc.), so that even when images taken by the video cameras 11 are not full-faced, the image-recognizing module 13 can still recognize and identify the a patient's identity. The video cameras 11 are evenly distributed over public areas, passageways and corridors of the hospital to cover as large visual scope as possible, such as: either or both sides or center of a passageway, and corners of a hall. Each of the video cameras 11 is programmed and identified with a unique set of location information related to an indoor site of the hospital. For instance, the video cameras 11 may be denominated as A, B, C, D . . . or according to areas, departments or rooms, or with precise coordinates. After making the patient identified, the video cameras 11 may then provide location information about the patient's present location. Afterward, the video cameras 11 may continue to capture the patient's face images, so as to enable the path-planning module 14 to track whether the patient is following the planned proceeding path. The image-recognizing module 13 continuously and quickly compares the patient's face images. After making the patient identified, the image-recognizing module 13 gets the location information of the relevant video cameras 11 as the basis of the patient's location information. When the patient's identity is successfully determined by the image-recognizing module 13, the image-capturing module 12 further captures the patient's body feature images, and all individuals presenting in the vision scope of the video cameras 11 for a predetermined time period. Afterward, the image-recognizing module 13 identifies those body feature images that match the body feature images of the patient. The individuals having those body feature images that match the body feature images of the patient is identified as the patient himself/herself. Then the image-capturing module 12 captures face images thereof and records these face images into the patient-data recording module 10. Thereby, the system automatically records patients' face images from various angles and “learns” to identify patients more quickly. The path-planning module 14, according to the patient's location and the current queue progress, calculates the shortest possible proceeding path, and provide outpatient-guiding information. The view-displaying module 15 displays the guiding information, such as: “Hello, Mr. XXX, if you are going to the ophthalmology department, please turn →,” or “Hello, Ms. XXX, to Room 3333, please go ↑.” Where the image-recognizing module 13 recognizes multiple patients through the video cameras 11, it split the screen into multiple views for showing the relevant guiding information according to priority of their objectives. The voice-broadcasting module 16 then converts the guiding information into a voice message, such as: “Hello, Mr. XXX, please turn right to the ophthalmology department,” or “Hello, Ms. XXX, please go straight if you are finding Room 3333.”

The present invention may work with a software program installed in mobile communication devices (such as smartphones, tablets, laptops, PDAs . . . ) or wearable devices (such as smart glasses, smart watches . . . ). In use, the disclosed system provides a patient with an exclusive, unique user name and a password. After the patient gets registered and validated, the software program connects the disclosed system through the network, and provides voice-based or image-based guidance in the patient's mobile communication device or wearable device synchronously. Further, a patient having made his/her appointment may be informed of the hospital's queue progress through the software program.

Moreover, when operating in the mobile communication device, the software program may work with positioning functions built in the mobile communication device, including: triangulation based on radio waves such as WI-FI, or Beacon Micro-positioning (not forming the features of the present invention and therefore not discussed in details), so as to provide the disclosed system with feedback that helps accelerate positioning the patient in the hospital even at places where no video cameras 11 are installed. This serves as an alternative for efficiently locating and finding the patient in a hospital. Of course, the image-recognizing module 13 of the present invention may be further connected to a list-screening module 17. The list-screening module 17 may contain a blacklist 171 prepared by a hospital or a blocked-person list 172 provided by the public security authority. Thereby, when there is an individual identified as a target of the list-screening module 17, the disclosed system warns the hospital of the suspicious person, so that the hospital can get prepared or expel the individual, and can continuously track whether the individual leaves the hospital.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An outpatient-guiding system, comprising:
a patient-data recording module, a plurality of video cameras, an image-capturing module, an image-recognizing module, a path-planning module, a plurality of view-displaying modules and a plurality of voice-broadcasting modules;
the patient-data recording module recording anamnesis data, face-image data, and appointment details of a patient, and using the appointment details to obtain an appointment time and an appointed department related to the patient and a hospital;
the video cameras being installed in passageways and corridors of the hospital;
the image-capturing module using the video cameras to capture face images of the patient and location information of the video cameras; the image-recognizing module comparing the patient's face images input by the image-capturing module to the face-image data stored in the patient-data recording module for apparent features, so as to determine the patient's identity;
the path-planning module, according to the patient's identity determined by the image-recognizing module and according to the location information of the video cameras, calculating the patient's present location and planning a proceeding path toward the appointed department;
the view-displaying modules being deployed along the hospital's passageways and corridors, and, according to the patient's present location and proceeding path planned by the path-planning module, displaying outpatient-guiding information through the view-displaying module locationally closest to the patient;
the plurality of voice-broadcasting modules being deployed along the hospital's passageways and corridors, and, according to the patient's present location and proceeding path planned by the path-planning module, broadcasting outpatient-guiding information using the voice-broadcasting module locationally closest to the patient.

2. The outpatient-guiding system of claim 1, wherein after the image-recognizing module determines the patient's identity, the image-capturing module captures body feature images of the patient and then captures body feature images of all individuals presenting in vision scope of the video cameras for a predetermined time period, after which the image-recognizing module identifies those body feature images that match the body feature images of the patient, and for individuals having those body feature images that match the body feature images of the patient, the image-capturing module captures face images thereof and records these face images into the patient-data recording module.

3. The outpatient-guiding system of claim 1, further comprising a list-screening module.

4. The outpatient-guiding system of claim 3, wherein the list-screening module contains a blacklist prepared by the hospital or a blocked-person list provided by a public security authority.
